(19) United States
(12) Patent Application Publication
(10) Pub. No.: US 2008/0262937 A1
(43) Pub. Date: Oct. 23, 2008

(54) METHOD AND SYSTEM FOR PERFORMING AUTOMATED GROUP PURCHASING

(76) Inventor: KERRY WAYNE WILLIS, Georgetown, TX (US)

Correspondence Address: IBM CORPORATION;C/O DARCELL WALKER, ATTORNEY AT LAW, P. O. Box 25048, HOUSTON, TX, 77265, US

(21) Appl. No.: 11/736,675

(22) Filed: Apr. 18, 2007

(51) Int. Cl. G06Q 30/00

(52) U.S. Cl. 705/26

(57) ABSTRACT

The present invention is an automated and online process for individual members of a group to perform online purchases under one group account. This method creates an account for the group with a particular merchant. The method uses purchaser information to generate a unique security key for the particular group purchase. The purchaser information includes a set of parameters that will govern a valid order by a group member. When a member of the group desires to make a purchase under the group account, that purchaser would use the key to gain access to the purchasing program. After the user has completed his/her menu selections, the purchaser would submit the order. The order is validated based on purchase criteria provided at the initiation of the account. After order validation, the order would be entered into a database containing the purchaser's account information. This process would also update the purchaser account information.

### FIELD OF THE INVENTION

The present invention relates to a method for performing automated purchasing a of a group sales order and in particular to a method for performing online group purchases, in which multiple people are ordering on the same purchasing transaction, using a customized purchasing certificate.

### BACKGROUND OF THE INVENTION

Customers are increasingly turning to computer networks, and the Internet in particular, to locate and purchase goods and services. So-called ‘online’ shopping involves the location and purchase of goods and/or services by way of a network. Increasingly, mobile phones and other wireless devices are being employed to this end.

Online purchasing is typically done by selecting items from an online catalog of items and adding them to an online shopping cart. Once all required items have been added to the shopping cart a payment method is selected and the order is submitted. The items may then be shipped to the customer's address.

Although many systems are currently in place to perform online purchasing operations, many ‘group orders’ are still performed by manual means. A group order in this context is described as several members from a group each having individual or unique orders included in one transaction. An example of group ordering is when the members of the group want to order a meal online. With the current approach, ordering items online for a group of people requires that someone manually take the orders and then input them on behalf of the members of the group. An example of this problem is when a manager orders lunch for a team of people. Someone has to create a list of orders. This activity requires the person to ask ea

Depending on the composition of the group and the location of the group members, the task of gathering the information about the preferences of the individual members can be quite long. There remains a need for an automated online ordering method and system that will enable members of a group to place individual orders and have their orders included in one group transaction.

### SUMMARY OF THE INVENTION

The present invention describes a method for individual members of a group to perform online purchases under one account. This method comprises an initial step of creating an account for the group with a particular merchant. The purchaser group would submit information to the merchant that will relate to the purchasing activity. The method would use this purchaser information to generate a unique security key for the particular group. When a member of the group desires to make a purchase under the group account, that purchaser would use the key to gain access to the purchasing program. After the user completed his/her menu selections, the purchaser would submit the order. At this point, the order would be validated using previously gathered purchaser information. If the order were validated, the order would be entered into a database containing the purchaser's account information. This process would also update the purchaser account information.

In the information submitted by the purchaser, the purchaser could define detailed parameters that would govern any transaction under that purchaser's account. For example, the purchase account could limit the total cost of any transaction. It could also limit the time period an individual member has to place an order. With this method, the purchaser cold limit the particular items one could purchase or nor purchase.

The system of the present invention would contain a database for storing client information. The database would also contain a set of security access keys. Each group would have an access key. The information contained on the access key could relate to the parameters that govern purchases under that account. The system has the processing software that determines whether one attempting to access the system is valid. When the user is valid, the system can contain another software routine that determines whether an order placed by the user is valid.

### DESCRIPTION OF THE DRAWINGS

FIG. 1 is a conventional computing device used that can be used to transmit and receive electronic messages via a computer network.

FIG. 2 is a diagram of a computer network over which electronic messages may be transmitted between a sender and receiver in the present invention.

FIG. 3 is a flow diagram of the general method of the present invention.

FIG. 4 is a flow diagram of the method on the merchant end for initiating and processing a group order.

FIG. 5a is a diagram of the fields that can comprise a security key for access to the system by an individual member of a group.

FIG. 5b are diagrams of various criterion used describe different group orders and used to comprise various fields of security key.

FIG. 5c illustrate correct and incorrect key entries for access to the account of a particular group.

FIG. 5d is an illustration of menu items as implemented in the present invention.

FIG. 6 is a detailed flow diagram of the steps in the method of the present invention.

FIG. 7 is a detailed flow diagram of the purchaser validation and order validation sequences of the present invention.

### DETAILED DESCRIPTION OF THE INVENTION

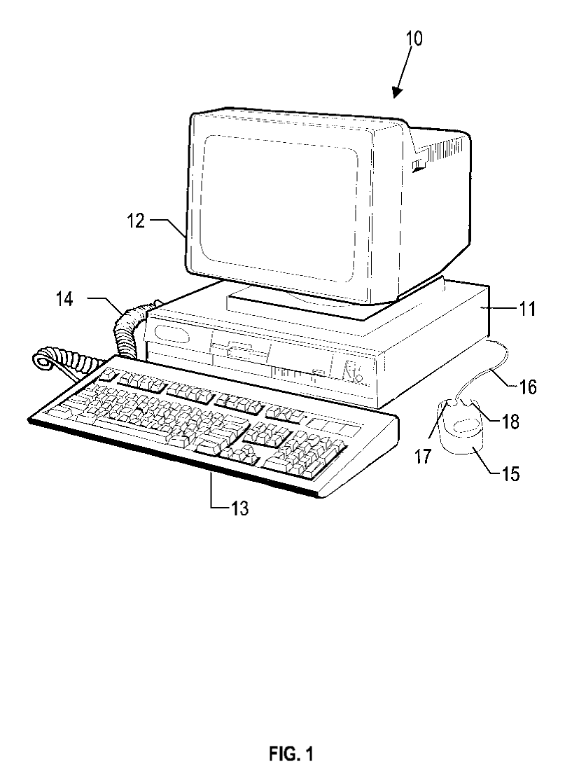

With reference now to FIG. 1, there is depicted a pictorial representation of computing device 10 which may be used in implementation of the present invention. As may be seen, data processing system 10 includes processor 11 that preferably includes a graphics processor, memory device and central processor (not shown). Coupled to processor 11 is video display 12 which may be implemented utilizing either a color or monochromatic monitor, in a manner well known in the art. Also coupled to processor 11 is keyboard 13. Keyboard 13 preferably comprises a standard computer keyboard, which is coupled to the processor by means of cable 14. Also coupled to processor 11 is a graphical pointing device, such as mouse 15. Mouse 15 is coupled to processor 11, in a manner well known in the art, via cable 16. As is shown, mouse 15 may include left button 17, and right button 18, each of which may be depressed, or “clicked”, to provide command and control signals to data processing system 10. While the disclosed embodiment of the present invention utilizes a mouse, those skilled in the art will appreciate that any graphical pointing device such as a light pen or touch sensitive screen may be utilized to implement the method and apparatus of the present invention. Upon reference to the foregoing, those skilled in the art will appreciate that data processing system 10 may be implemented utilizing a personal computer.

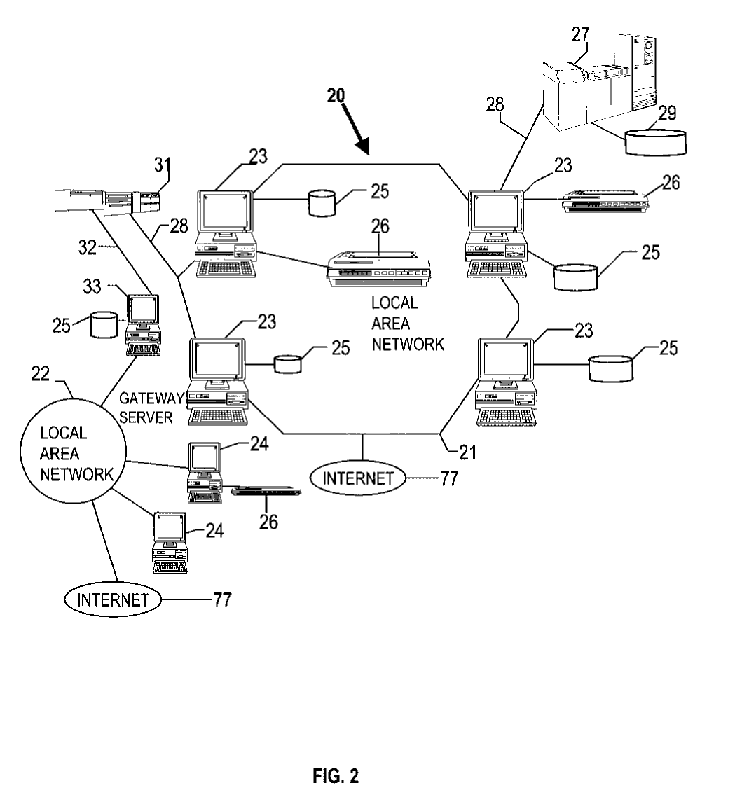

The method of the present invention may be implemented in a global computer network environment such as the Internet. With reference now FIG. 2, there is depicted a pictorial representation of a distributed computer network environment 20 in which one may implement the method and system of the present invention. As may be seen, distributed data processing system 20 may include a plurality of networks, such as Local Area Networks (LAN) 21 and 22, each of which preferably includes a plurality of individual computers 23 and 24, respectively. Of course, those skilled in the art will appreciate that a plurality of Intelligent Work Stations (IWS) coupled to a host processor may be utilized for each such network. Any of the processing systems may also be connected to the Internet as shown. As is common in such data processing systems, each individual computer may be coupled to a storage device 25 and/or a printer/output device 26. One or more such storage devices 25 may be utilized, in accordance with the method of the present invention, to store the various data objects or documents which may be periodically accessed and processed by a user within distributed data processing system 20, in accordance with the method and system of the present invention. In a manner well known in the prior art, each such data processing procedure or document may be stored within a storage device 25 which is associated with a Resource Manager or Library Service, which is responsible for maintaining and updating all resource objects associated therewith.

Still referring to FIG. 2, it may be seen that distributed data processing system 20 may also include multiple mainframe computers, such as mainframe computer 27, which may be preferably coupled to Local Area Network (LAN) 21 by means of communications link 28. Mainframe computer 27 may also be coupled to a storage device 29 which may serve as remote storage for Local Area Network (LAN) 21. A second Local Area Network (LAN) 22 may be coupled to Local Area Network (LAN) 21 via communications controller 31 and communications link 32 to a gateway server 33. Gateway server 33 is preferably an individual computer or Intelligent Work Station (IWS), which serves to link Local Area Network (LAN) 22 to Local Area Network (LAN) 21. As discussed above with respect to Local Area Network (LAN) 22 and Local Area Network (LAN) 21, a plurality of data processing procedures or documents may be stored within storage device 29 and controlled by mainframe computer 27, as Resource Manager or Library Service for the data processing procedures and documents thus stored. Of course, those skilled in the art will appreciate that mainframe computer 27 may be located a great geographical distance from Local Area Network (LAN) 21 and similarly Local Area Network (LAN) 21 may be located a substantial distance from Local Area Network (LAN) 24. That is, Local Area Network (LAN) 24 may be located in California while Local Area Network (LAN) 21 may be located within Texas and mainframe computer 27 may be located in New York.

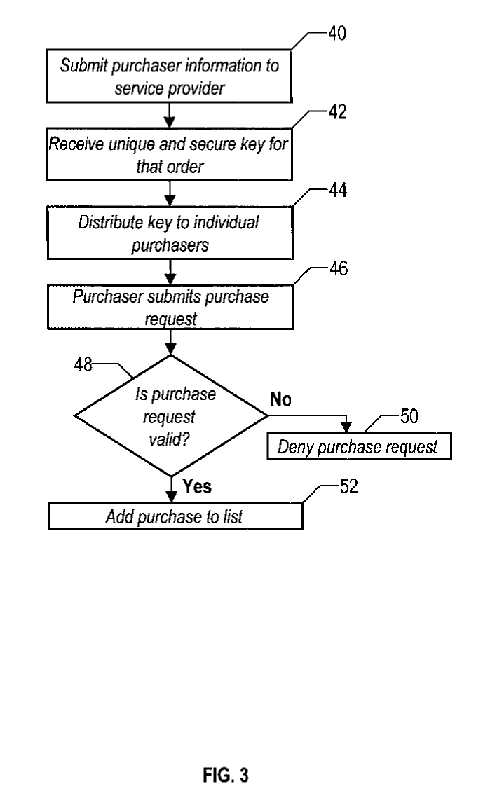

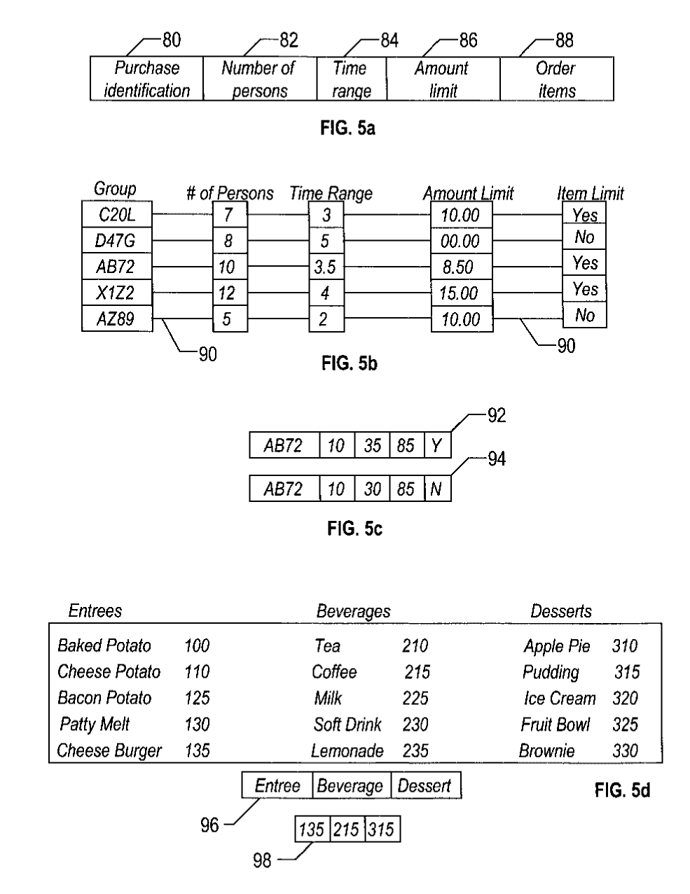

FIG. 3 illustrates the general steps in the implementation of the present invention. In this invention, a group wants to place an order for multiple items. In addition, each member of the group will place their individual orders. Each individual's order will be included in the total order for that group. The description of the implementation of this invention is in the context of a group ordering meals from a restaurant. Initially, there is an arrangement and setup between the purchaser and the merchant (restaurant) to access this service. This arrangement comprises establishing some for of account. As part of setup, the group could receive a unique identification number, such as ‘AB72’. When the purchaser wants to submit a group order, in step 40, a representative from the purchaser would submit (via a terminal device of FIG. 1 and through a network such as shown in FIG. 2) information to the merchant that characterizes the order. This information as shown in FIG. 5a can include 1) the number of persons in the will place orders, 2) the time period to place an order, 3) the maximum dollar amount of an order and 4) a list of forbidden order items. Step 42 receives this information and generates a unique security key for that purchaser that covers the specific order. As shown in FIG. 5b, this key can comprise information that is unique to that order. Step 44 distributes this unique security key to each member of the purchaser group. At this point, in step 46, a member of the purchaser group submits an order request. Step 48 validates this order request. The validation process can involve a verification of the information contained in the unique key submitted by the purchaser. If the key submitted by the member attempting to place the order does not match the key for that group, step 50 denies the purchase request. If the step 48 validates the key, then the member can place an order and step 52 adds that order to the purchase list for that purchaser group.

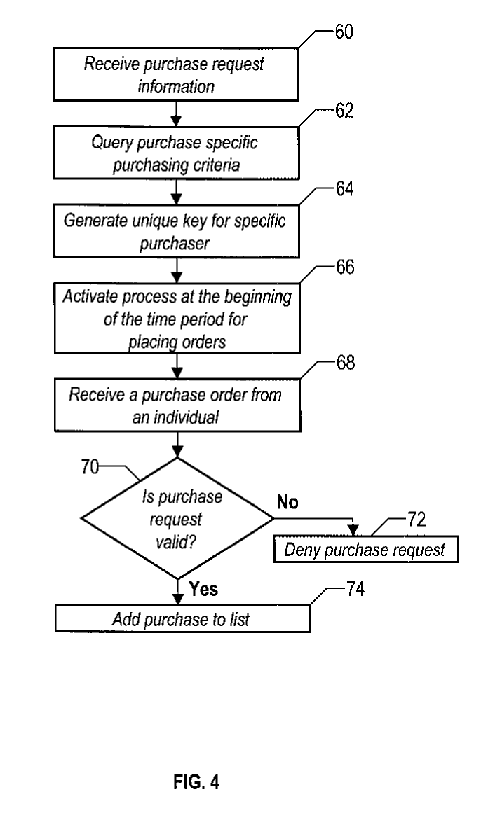

FIG. 4 is a flow diagram of the method on the merchant end for initiating and processing a group order. In the initial step 60, a purchase request is received at the merchant processing software. At this point, in step 62, the method sends to the potential purchaser a query for specific information about the order. Part of this query can be for the purchaser to identify whether they are new or whether they have a previously existing account. An existing purchaser would probably be asked to include their account identification. With the purchasing criteria information received from the query, step 64 would generate a unique security key for that purchaser. At the completion of the setup, the process would go into monitor mode for this particular order. As part of the order criteria, there can be a designated time period to place orders. For example, if the time were currently 8:00 am and the order time period is 10:00 am to 11:30 am, then activation would occur at 10:00 am, but not before that time. If a member attempted to order before 10:00 am, the system would not recognize the order. At 10:00 am, step 66 would activate the process to receive orders. Step 68 receives an order from an individual in the purchaser group. As previously discussed, step 70 validates this order request. The validation process can involve a verification of the information contained in the unique key submitted by the purchaser. If the key submitted by the member attempting to place the order does not match the key for that group, step 72 denies the purchase request. If the step 70 validates the key, then the member can place an order and step 74 adds that order to the purchase list for that purchaser group.

FIG. 5a is a diagram of the fields that can comprise a security key for access to the system by an individual member of a group. The number of fields can vary as desired and can contain various kinds of information as desired. The information that comprises the security key can directly relate to a particular transaction. As shown, in FIG. 5a, this key has five fields. The first field 80 can contain an identifier for the purchaser group. The second field 82 contains the number of persons in the group that will place orders. This field can serve as a security mechanism to prevent more orders added to the account than the purchasing group desires. Field 84 is a time range. As previously mentioned, the purchaser can designate a time period in which the orders are to occur. Field 86 attaches a maximum dollar amount to each order. Another approach is to have a maximum dollar amount for the entire group. However, the maximum per individual approach may better reduce potential confusion if a group maximum is reached before everyone in the group has had an opportunity to order. Field 88 restricts the orders to certain items on the menu. For example, if the purchase does not want anyone to order an appetizer or alcoholic beverage, then an attempt to order an appetizer or alcoholic beverage would cause a rejection of the specific containing the prohibited item(s).

FIG. 5b shows the information in the fields as the information may appear in a database. As shown, each category of information would be stored in records. These records could have pointers 90 to the next item in the field in the record. FIG. 5c shows an example of a generate security key used in the present invention. This figure also shows how a key entry would appear for someone attempting to gain access to this online ordering process. Key 92 is a legitimate and correct key entry for someone in group ‘AB72’. The group identity is the ‘AB72’ entry shown in the first field. This group identification tells the process which record to examine. This particular key contains the parameters that form the order criterion for that group. The ‘10’ is the maximum number of persons that place orders. The ‘35’ is the time period to place the order. In this example, the 35 number stands for three and one-half hours. The amount limit is $8.50. For this group, there is an item limitation as indicated by the ‘Y’. Entry 94 is an incorrect key entry. In this entry, the time range and the item limitation fields are incorrectly entered. This key entry would not match and therefore the individual would not receive access to place an order. FIG. 5d shows menu items coded to allow individuals to identify the items and place orders. Each item has a coded that the individual can enter to indicate the ordering of that item. The menu can have various categories of items such as entrees, beverages and desserts. A record for each order can also fields that correspond to the various categories. In implementation, an individual placing an order would enter the corresponding number for the desired item in the appropriate field. Record 98 shows an order that includes a cheese burger (135), coffee (215) and pudding (315). Each category of items can have an identifier number. For example, all entrees are 100's, all beverages are 200's and all deserts are 300's.

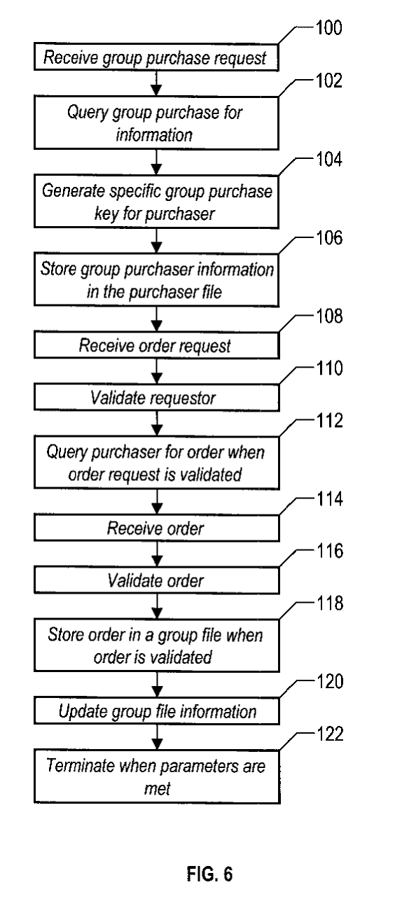

FIG. 6 is a detailed flow diagram of the steps in the method of the present invention. As previously mentioned, a group purchaser desires to arrange a group order at the merchant establishment. The steps in the transaction would occur over a communications network and could electronic devices such as the terminal described in FIG. 1. In step 100, the process receives a group purchase request. Step 102 would send a query to the group purchaser making the request. The group purchase requester would then submit information describing the order. The query sent to the purchaser could be in the form of a questionnaire containing fields in which the purchaser would supply information. The above-mentioned fields for number of persons, time range, amount limit and item limit would have fields in which the purchaser would enter information. After receiving the query information, step 104 would generate a specific security key for that group and that transaction. If the purchaser is a repeat purchaser, the purchaser identification may be the same for multiple orders or it could be the same each time that purchaser arranges a group order purchase. Step 106 would then store in a database or storage location, the information about the order for the particular purchaser.

At this point, the system could go into an idle and monitoring mode until the start of the order time period. This process can have a clock or timer that will trigger to activate the process for this account at the beginning of the time period for this particular order. Another approach to activating an order at the beginning of the time period is for there to be a set of active orders and a set of inactive orders (those whose start time has not yet been reached). The process would only monitor the active orders. If someone attempted to order before the beginning of the time period, the process would not recognize the order because that order would be in the inactive set.

The process receives an order in step 108. Next, in step 110, the process validates the individual attempting to place an order. This requestor validation queries the individual for the key. The individual should have previously received the key. The requestor enters information in designated fields. This information is compared with the key for that order. When there is a match, the process validates the requester, which allows the requester to place an order. Step 112 will query the requester to place an order. This query can have the requester provide information for specific fields as shown in FIG. 5d. Again, the process receives the order in step 114. In step 116, the process validates this order. This validation can vary depending on the requirements of the order. Since in FIG. 5b, there is an item limitation, each item code has to be checked to verify that the selected item is a permissible item. If there were no item limitation, this check would not be necessary. Without the item limitation, the next check would be to total up the cost of the items to determine whether this total exceeds a maximum amount for each individual. In the database each menu item would have the identification code and also the item price. This price is used to determine the total cost of the article. If there were a prohibited item or if the cost exceeded the maximum, the requestor would be prompted to resubmit the order. The requestor could also be told the nature of the problem with the previously submitted order. At the point, when the order is completed and validated, step 118 stores the order in the database under the account for that group purchaser. Step 120 will update the group file information to reflect the newly taken order. As part of the update, the number of persons having submitted ordered would be incremented. This update is important because step 122 terminates the process when the designated number of persons have ordered.

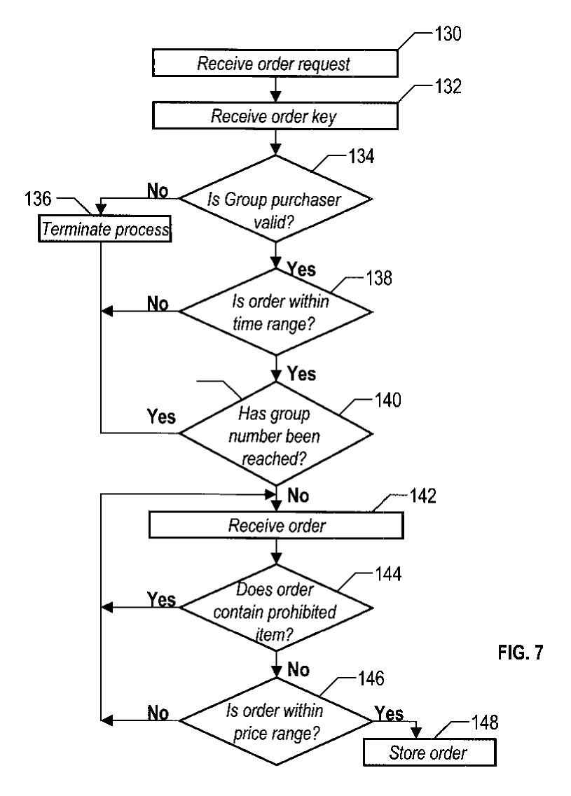

FIG. 7 is a detailed flow diagram of the purchaser validation and order validation sequences of the present invention. In step 130, the process receives the order request. After the purchaser query, step 132 receives the order key. Step 134 validates the group purchaser key. As mentioned, this validation process comprises the comparison of a key entry by a requestor with the established generated key for that particular account. If the key is not a match, step 136 rejects the access attempt and terminates the process. If the key entry is valid (matches the generated key), the process moves to the second step 138 of the validation, which is a determination of whether the attempted order is in the time range for orders for this particular account. If the attempted is not within the time period for that order, again the process terminates in step 136. When the order is within the time period, the process moves to step 140, which determines whether the maximum number of orders has been reached. If the maximum number of orders has already been reached, the process again terminates in step 136. When the maximum of orders has not been reached, the process moves to step 142. At this point, the process has completed the group purchaser validation process.

In step 142, the process receives an individual order. The individual has indicated their menu preferences. In step 144, there is a determination of whether the order contains prohibited items. Comparing the selected items to a list of prohibited items can perform this task. When there are no matches, then the selected items are allowable and the process continues. If the order does contain a prohibited item, the purchaser is alerted of the problem and the process returns to step 142 where the requestor is prompted to resubmit the order. As previously mentioned, this particular step of checking for prohibited items is done only if this category of prohibited items is initially selected. When the order with regard to prohibited items is valid, the next step 146 is to determine if the total amount of the order exceeds the maximum order amount for an individual. If the order exceeds this amount, the process alerts the requestor and the process returns to step 142 where the requester is prompted to resubmit the order. When the order with regard to price is valid, the order validation is complete. The process then moves the step 148, which stores the order.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

We claim:

1. A method for performing automated group purchasing comprising the steps of:
establishing an automated group purchasing account between a merchant that supplies a product or a service and a group purchaser which has individual members that will be able to submit orders under the group purchaser account in which the individual orders will be complied into one group order;
validating a security key submitted by an individual group member when that member attempts to submit an order;
receiving and validating an order from an individual group member when there is a determination that the security key submitted by the individual group member is valid; and
storing a validated individual order.

2. The method as described in claim 1 wherein said account establishing step further comprises the steps of:
querying the group purchaser for information related to a purchase that will occur under the group purchaser;
receiving the group purchaser information; and
generating a security key for access by individual members of the group purchaser.

3. The method as described in claim 2 further comprising the step of creating and storing a record in a database with fields and information corresponding to the information contained in the generated key.

4. The method as described in claim 1 further comprising the step of creating an automated listed/menu of items from which an individual group member can place an order, the list containing various categories of items and codes associated with each category of item and each specific item.

5. The method as described in claim 1 wherein the security key validating step further comprises the steps of:
retrieving the group purchasing key for a particular purchasing transaction;
receiving key information from a requestor attempting to submit an order;
comparing various portions of the received requestor key information with corresponding portions of the security key; and
validating entered key information when all portions of that received key information matches the security key.

6. The method as described in claim 2 wherein query information can include requesting purchase order limiting parameters such as: the number of individual orders to be accepted, time range for accepting the individual orders, maximum cost per individual order and permissible items for an order.

7. The method as described in claim 6 wherein said order validating step further comprises determining whether an individual group member order complies with each order limiting parameter that is directly related to each item contained in the individual group member order.

8. The method as described in claim 7 wherein said order validating step further comprises submitting a reply to an individual group member in response to a received order, the reply indicating invalid information in an order submitted by the individual group member, the reply also providing an opportunity for the individual group member to resubmit a corrected order.

9. The method as described in claim 8 wherein said order validating step further comprises the step of tracking any order resubmission activity and terminating an order attempt of an individual group member when the individual group member submits a predetermined number of consecutive invalid orders.

10. A computer program product in a computer readable storage medium for performing automated group purchasing comprising:
instructions for establishing an automated group purchasing account between a merchant that supplies a product or a service and a group purchaser which has individual members that will be able to submit orders under the group purchaser account in which the individual orders will be complied into one group order;
instructions for validating a security key submitted by an individual group member when that member attempts to submit an order;
instructions for receiving and validating an order from an individual group member when there is a determination that the security key submitted by the individual group member is valid; and
instructions for storing a validated individual order.

11. The computer program product as described in claim 10 wherein said account establishing instructions further comprise:
instructions for querying the group purchaser for information related to a purchase that will occur under the group purchaser;
instructions for receiving the group purchaser information; and
instructions for generating a security key for access by individual members of the group purchaser.

12. The computer program product as described in claim 10 further comprising the step of creating an automated listed/menu of items from which an individual group member can place an order, the list containing various categories of items and codes associated with each category of item and each specific item.

13. The computer program product as described in claim 10 wherein the security key validating step further comprises instructions for:
retrieving the group purchasing key for a particular purchasing transaction;
receiving key information from a requester attempting to submit an order;
comparing various portions of the received requester key information with corresponding portions of the security key; and
validating entered key information when all portions of that received key information matches the security key.

14. The computer program product as described in claim 11 wherein query information instructions can include instructions for requesting purchase order limiting parameters such as: the number of individual orders to be accepted, time range for accepting the individual orders, maximum cost per individual order and permissible items for an order.

15. The computer program product as described in claim 14 wherein said order validating instructions further comprise instructions for determining whether an individual group member order complies with each order limiting parameter that is directly related to each item contained in the individual group member order.

16. The computer program product as described in claim 15 wherein said order validating instructions further comprise instructions for submitting a reply to an individual group member in response to a received order, the reply indicating invalid information in an order submitted by the individual group member, the reply also providing an opportunity for the individual group member to resubmit a corrected order.

17. The computer program product as described in claim 16 wherein said order validating instructions further comprise instructions for tracking any order resubmission activity and terminating an order attempt of an individual group member when the individual group member submits a predetermined number of consecutive invalid orders.

18. A system for performing automated group purchasing comprising:
an order input device used by an individual group member to place an order with a merchant under an established group purchasing account between a merchant that supplies a product or a service and a group purchaser which has individual members that will be able to submit orders under the group purchaser account in which the individual orders will be complied into one group order;
an order receiving element being accessible by an order input device for accepting individual group members;
order processing element in said order receiving element comprising:
a routine for generating a security key for a group order;
a database for storing group order criteria, which will govern individual group member order attempts;
a security key validating routine; and
an individual order validating routine; and
a communication network to enable the transmission of information between said order input device and said order receiving device.

19. The system as described in claim 18 wherein the security key group comprises order criteria for governing individual group member order attempts, the security key containing fields with each field containing information for on one of the order criteria.

20. The system as described in claim 19 wherein a received order comprises a record containing for in which order input information is input, the order record having fields for information for each order criteria, the order record having fields that correspond to order criteria contained in the security key.
